(19) United States
(12) Patent Application Publication
(10) Pub. No.: US 2010/0274525 A1
(43) Pub. Date: Oct. 28, 2010

(54) Laser Scanning Measurement Systems And Methods For Surface Shape Measurement Of Hidden Surfaces

(75) Inventor: Leon Robert Zoeller, III, Hammondsport, NY (US)

Correspondence Address: CORNING INCORPORATED, SP-TI-3-1, CORNING, NY, 14831, US

(73) Assignee: Corning Incorporated, Corning, NY (US)

(21) Appl. No.: 12/739,838

(22) PCT Filed: Oct. 28, 2008
(86) PCT No.: PCT/US08/12194

§ 371 Date: Apr. 26, 2010

Related U.S. Application Data
(60) Provisional application No. 61/001,271, filed on Oct. 31, 2007.

(51) Int. Cl. G01B 11/24; G06F 15/00

(52) U.S. Cl. 702/167; 356/612

(57) ABSTRACT

Laser scanning measurement systems and methods are disclosed that allow for surface shape measurements of otherwise hidden portions of an object's surface. The system includes a laser system that scans a laser beam over a scan path, a photodetector that detects light reflected from the object's surface, and a processor adapted to process detector signals from the photodetector to determine a two-dimensional (2D) surface shape representation and a three-dimensional (3D) surface shape profile representation. The system includes a mirror(s) configured to direct the scanned laser beam to one or more portions of the object surface that cannot be directly irradiated by the laser, and that allows the photodetector to detect light reflected from the one or more hidden portions via the mirror(s). The laser scanning measurement system is able to measure, in a single laser beam scan, some or all of the hidden portion(s) of an object rather having to rotate the object or having to use multiple scanned laser beams or multiple scanning systems.

### RELATED APPLICATIONS

This application claims the benefit of U.S. Provisional Application No. 61/001,271 filed Oct. 31, 2007, entitled “Laser Scanning Measurement Systems and Methods for Surface Shape Measurement of Hidden Surfaces.”

### BACKGROUND

The present invention relates generally to laser measurement systems for measuring surface shapes, and in particular to such laser scanning systems capable of measuring surface portions that are otherwise hidden from direct impingement of a scanning laser beam.

Laser scanning measurement systems measure the profile (shape) of the surface of an object, and are used in a variety of applications, such as art (e.g., sculpture), architecture, industrial design, and product inspection. In one type of laser scanning measurement system, a laser emits a narrow light pulse directed to the object's surface, forming a small spot on the object. A portion of the light that forms the laser spot is reflected by the surface and is detected by a photodetector. The photodetector typically includes, for example, a charge-coupled device (CCD) array, so that the location of the detected laser spot can be determined. By knowing the distance between the laser and the detector, the angle formed by the reflected laser spot and the detector, and the angle of the laser beam as formed at the laser, the relative position of the surface from which the laser spot reflected is established. By moving (“scanning”) the laser spot (or in some cases, a laser line) over the surface, the entire three-dimensional (3D) surface profile can be measured.

FIGS. 1A through 1C illustrate a typical measurement scenario using a laser scanning measurement system 10 to measure the shape of a surface 22 of an object 20 such as a cylinder. Laser system 10 includes a laser source 12, a detector unit 14, and a processor (e.g., a computer) 18 operably coupled to the laser source and detector unit. Processor 18 processes detector signals from detector unit 14.

In the operation of system 10, laser 12 emits a laser beam 16 over a total scan path SP_{T} having a corresponding angular range (“beam angle”) θ_{T}. As shown in FIG. 1A, system 10 can only measure a portion of surface 22—namely, the exposed surface portion 22A that faces laser 12 and that subtends the beam angle θ_{T}. The other portions of surface 22, identified as 22B and 22C, remain hidden from the laser beam and so remain unmeasured. To measure hidden surface portion 22B, object 20 is rotated (or system 10 is moved) so that surface portion 22B is within the beam angle θ_{T} of scan path SP_{T}, as shown in FIG. 1B. A second laser scan is then taken. After this second scan, if the remainder of object 20 is to be measured, it must be rotated again to bring surface portion 22C to within beam angle θ_{T} of scan path SP_{T}, as shown in FIG. 1C. Depending on the beam angle θ_{T} of scan path SP_{T}, this rotation/measurement process may need to be repeated even more times until the entire surface 22 is measured.

The different scanned views must then be pieced together (e.g., by processor 18) to form a complete measurement of surface 22 at the given circumference. Unfortunately, this repeated process is time consuming and often does not arrive at the correct shape. Further, human intervention may be needed to perform the object rotation, which further delays and complicates the surface measurement process. Moreover, not all objects are amenable to rotation. For example, soft objects may change shape when rotated.

### SUMMARY

In one aspect, a laser measurement system is disclosed herein for measuring a surface of an object held at an object position. The system comprises a laser source adapted to scan a laser beam over a scan path relative to the object position. A mirror system comprising at least one mirror is arranged relative to the laser source and to the object position such that the scanned laser beam is incident directly on an exposed portion of the object surface and is also incident via reflection by the mirror system onto at least one hidden portion of the object surface that is not directly accessible by the scanned laser beam. A photodetector is configured relative to the laser source, the mirror system and the object position, so as to detect light from the scanned laser beam that reflects directly from the exposed surface portion and that reflects from the at least one hidden surface portion to the photodetector via the mirror system.

In another aspect, a method is disclosed herein of performing a non-contact measurement of a surface of an object using a single scan of a laser beam. The method comprises scanning a first portion of the object surface with the laser beam. The method also comprises scanning a second portion of the object surface with the laser beam, wherein said second surface portion cannot be directly irradiated by the laser beam. This is accomplished by reflecting the laser beam to the second portion. The method further comprises detecting light reflected by the first surface portion and second hidden surface portion. The method also comprises determining a surface shape representation of the object surface based on the detected light. The object is preferably not moved during the scanning, for example with respect to the laser source. Preferably, the object is not rotated during the scanning.

In another aspect, a laser scanning measurement system is disclosed herein for measuring a surface of an object having a circumference. The system comprises a laser source adapted to provide a laser beam that scans over a scan path. The system has an object holder adapted to hold the object at an object position relative to the laser source such that the object has i) an exposed surface portion upon which the scanned laser beam can be made directly incident and ii) at least one hidden surface portion upon which the scanned laser beam cannot be made directly incident. A mirror system is arranged relative to the object holder and to the laser source such that the scanned laser beam can be made incident upon the at least one hidden surface portion as the laser beam is scanned over the scan path. The system also comprises a photodetector adapted to receive light reflected directly from the exposed surface portion and light reflected from the at least one hidden surface portion via said mirror system, and to generate detector signals corresponding to said detected light from said surface portions. The system further comprises a processor adapted to receive and process the detector signals to determine a surface shape representation of the object surface.

Additional features and advantages of the invention are set forth in the detailed description that follows, and will be readily apparent to those skilled in the art from that description or recognized by practicing the invention as described herein, including the detailed description that follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and, together with the description, serve to explain the principles and operations of the invention.

### BRIEF DESCRIPTION OF THE DRAWINGS

FIGS. 1A-1C are schematic diagrams of a prior art laser scanning measurement system, illustrating how multiple scans are needed to measure the hidden surface portions of an object;

FIG. 2A is a schematic diagram of a first exemplary embodiment of a laser scanning measurement system according to the present invention that can measure an otherwise hidden surface portion of an object;

FIG. 2B through FIG. 2D illustrate an exemplary embodiment of a surface measurement process for measuring the otherwise hidden surface portion(s) of an object using the example measurement system of FIG. 2A;

FIG. 3A is a perspective view of an example cylindrical object whose surface is to be measured, illustrating the laser spot and the scanning direction of the laser spot over the object's surface;

FIG. 3B is a side view of an exemplary embodiment of an object holder that holds the cylindrical object of FIG. 3A at its respective ends so that the entire surface can be accessed both directly and indirectly by the scanned laser beam;

FIG. 3C is an end-on view of an exemplary embodiment of an object holder that holds the cylindrical object of FIG. 3A by supporting it in a V-groove type of mount so that only a small portion of the object's surface is not accessible to the scanned laser beam;

FIG. 4 is a flow diagram that describes an exemplary embodiment of a method of measuring both the exposed and hidden portion(s) of an object using the measurement system of FIG. 2A and FIG. 6A;

FIG. 5 plots the resulting surface shape segments as obtained using the system of FIG. 2A prior to the segments being combined to form the corresponding surface shape representation, and also shows the coordinate transformation used to combine the surface shape segments to form the corresponding surface shape representation;

FIG. 6A is a schematic diagram of a second exemplary embodiment of a laser scanning measurement system according to the present invention that can measure an entire surface of an object using a single scan even when portions of the object surface are otherwise hidden from direct measurement by the scanning laser beam;

FIG. 6B is a schematic perspective diagram of an exemplary embodiment of a mirror system that comprises two plane mirror sections;

FIG. 6C is the same schematic diagram of FIG. 6A, but showing the laser beam scan path;

FIG. 6D is the same schematic diagram of FIG. 6C, but showing how the laser beam scan path of FIG. 6C is divided up into different scan path segments;

FIG. 6E through FIG. 6I illustrate an exemplary embodiment of a surface measurement process for measuring the otherwise hidden surface portion(s) of an object using the example measurement system of FIG. 6A;

FIG. 7A plots the resulting surface shape segments as obtained using the system of FIG. 6A prior to the segment being combined to form the corresponding surface shape representation;

FIG. 7B illustrates how the surface shape segments of FIG. 7A undergo a coordinate transformation and are combined to form the corresponding surface shape representation;

FIG. 8A is a schematic diagram similar to FIG. 2A, illustrating the geometry for the coordinate transformation used to combine the surface shape segments;

FIG. 8B is a close-up view of an example mirror of the mirror system shown in the system of FIG. 8A, wherein the mirror comprises opaque stripes used to indicate the mirror position in each object scan that comprises the mirror;

FIG. 9A is an end-on view of an example of an extruded-type particulate filter that can serve as an object whose surface can be measured by the laser scanning measurement system of the present invention;

FIG. 9B is a side view of the filter of FIG. 9A;

FIG. 9C is the side view similar to that of FIG. 9A, illustrating a bowed surface shape defect in the extruded log that forms the filter body; and

FIG. 9D is a side view similar to FIG. 9C, illustrating a flared-end surface shape defect that arises when cutting the extruded log to form the filter body.

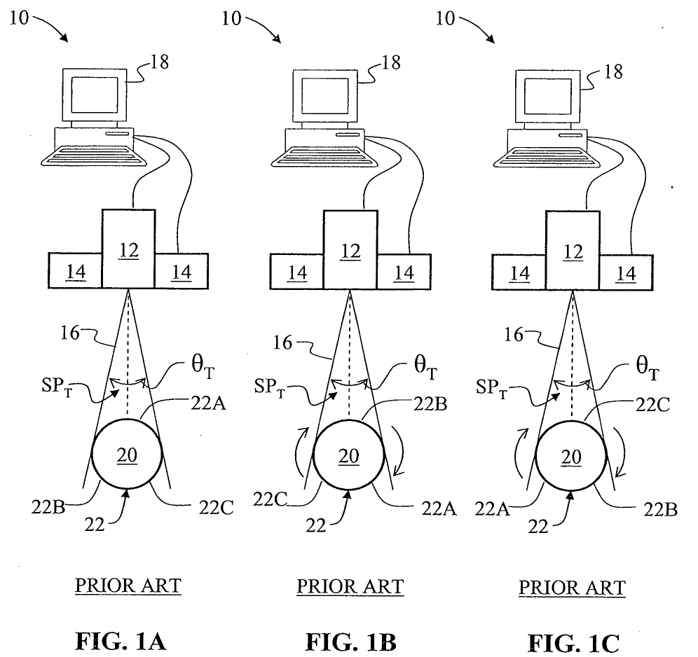

### DETAILED DESCRIPTION

Reference is now made in detail to the present preferred embodiments of the invention, examples of which are illustrated in the accompanying drawings. Whenever possible, the same or analogous reference numbers are used throughout the drawings to refer to the same or like parts.

### Single-Mirror Embodiment

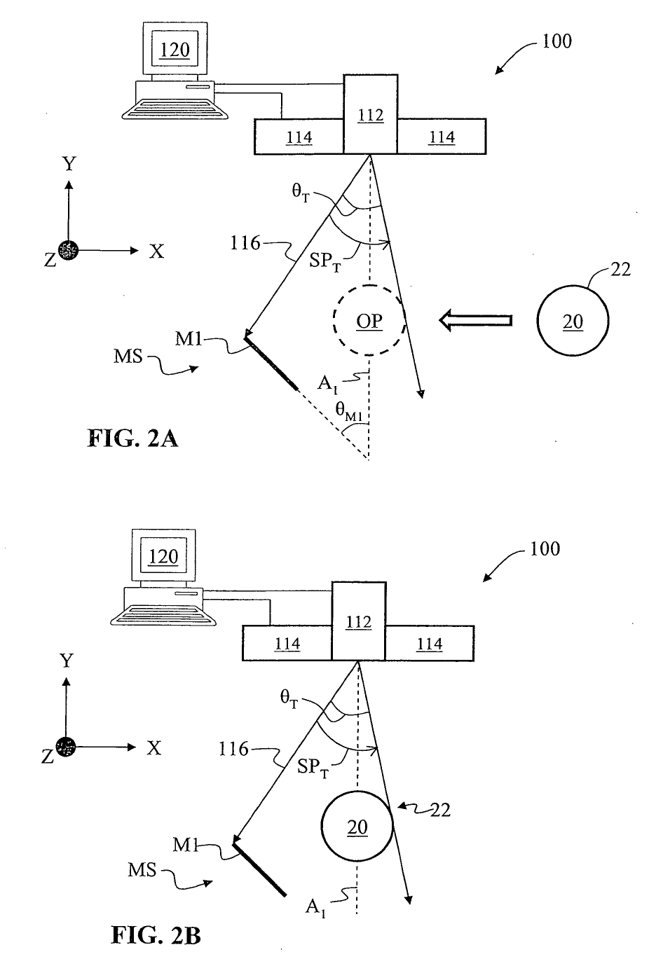

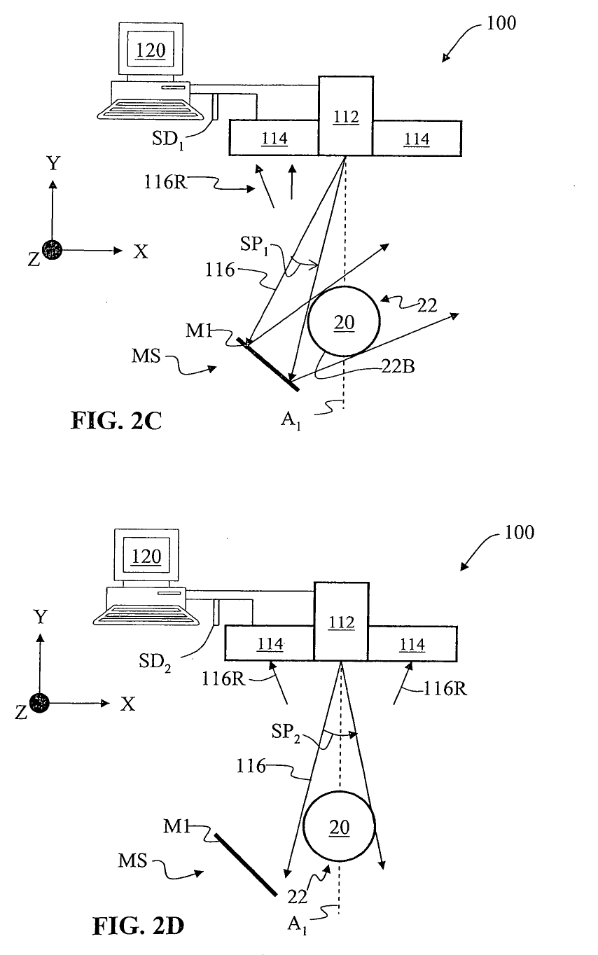

FIG. 2A is a schematic diagram of an exemplary embodiment of a laser scanning measurement system 100 for measuring a surface 22 of an object 20 arranged at an object position OP. FIG. 2B through FIG. 2D illustrate an exemplary embodiment of a surface measurement process according to the present invention. A Cartesian coordinate system is included in select Figures for the sake of reference.

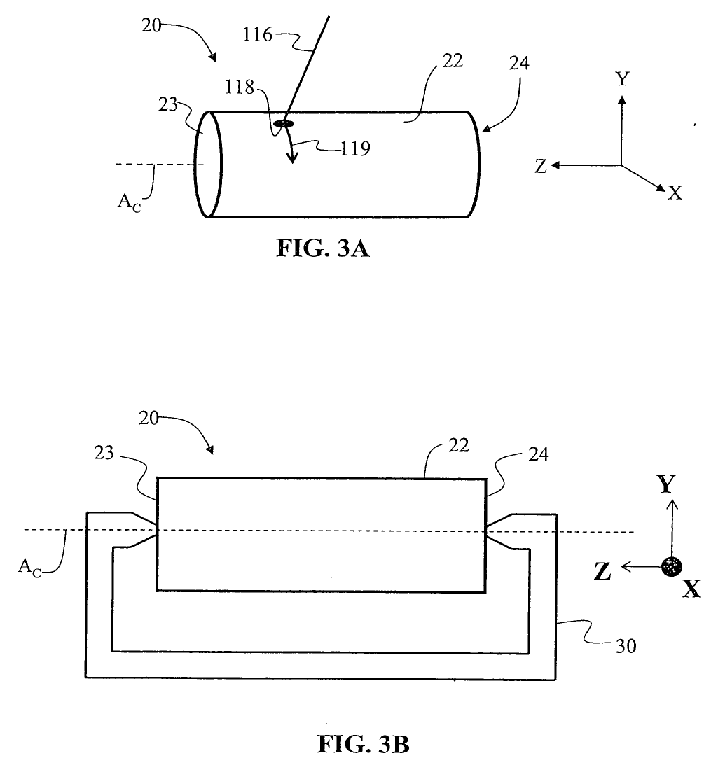

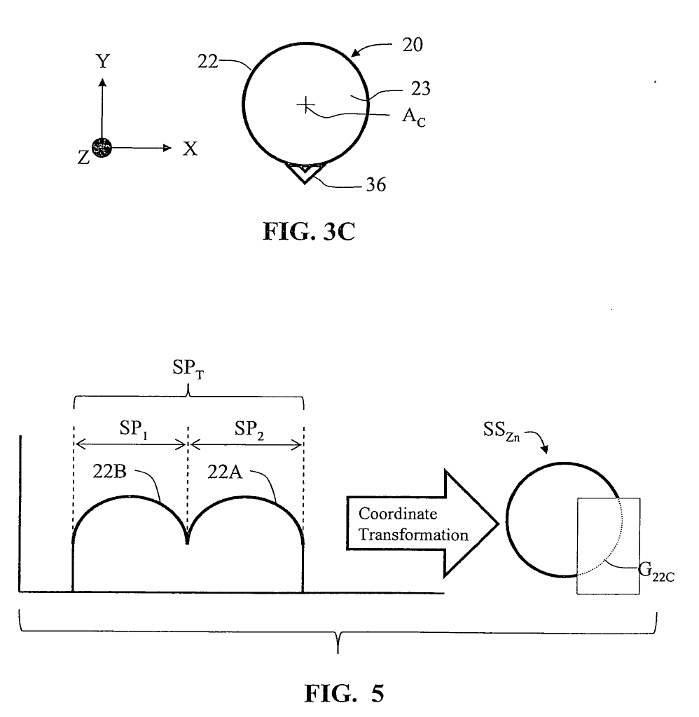

FIG. 3A is a perspective view of an example cylindrical object 20 whose surface 22 is to be measured. Object 20 has a central axis A_{C}, an object surface 22 and opposite ends 23 and 24. In an exemplary embodiment illustrated in FIG. 3B, object 20 is supported at ends 23 and 24 by an object holder (mount) 30 so that that access to object surface 22 is unobstructed. In another exemplary embodiment illustrated in FIG. 3C, object 20 is supported by a V-groove object holder 36 that runs the length of the object (or a portion of the length sufficient to support the object) so that access to object surface 22 is only marginally obstructed. In the exemplary embodiments discussed below, object surface 22 comprises three surface portions 22A, 22B and 22C for the sake of illustration. However, object surface 22 can be divided up into any reasonable number of surface portions, depending on the particular measurement geometry and the particular object being measured. The dividing of object surface 22 into different portions is merely for the sake of convenience and need not be related to features on the object surface per se.

With reference to FIG. 2A and FIG. 2B, system 100 comprises a laser source 112 adapted to form a scanned laser beam 116 over a total scan path SP_{T} that has an associated total beam angle θ_{T}. As illustrated in FIG. 3A, laser beam 116 forms a small laser spot 118 on object surface 22 that is scanned in a given direction 119. A photodetector 114 is arranged relative to laser source 112 and is adapted to detect reflected light 116R (as illustrated, for example, in FIGS. 2C and 2D) reflected from spot 118 at object surface 22. Photodetector 114 comprises, for example, a CCD camera. Photodetector 114 is shown as residing on either side of laser source 112 so as to have a relatively wide field of view in detecting light reflected 116R from different points on object surface 22.

System 100 also comprises a processor 120, such as a computer (e.g., a personal computer) that is adapted to receive electrical detector signals SD from photodetector 114 and process these signals to calculate one or more surface shape segments, surface shape representations, and three-dimensional surface profiles, as discussed below. In an exemplary embodiment, processor 120 comprises a microprocessor 122, such as a field-programmable gate array (FPGA), a central processing unit (CPU) or the like, that is programmable to carry out logic operations and in particular mathematical calculations. In an exemplary embodiment, processor 120 comprises image processing software typically used in laser scanning measurement systems to calculate surface shapes and surface profiles. Processor 120 may also include a memory unit (not shown) for storing information from the various detector signals as discussed below.

System 100 further comprises a mirror system MS, arranged relative to object position OP and laser source 112. In the present exemplary embodiment, mirror system MS comprises a mirror M1. In a preferred embodiment, mirror M1 is a plane mirror as shown, though other mirror shapes can be used. Mirror M1 forms an angle θ_{M1} with a system central axis A₁. Mirror system MS allows for a relatively large total scan path SP_{T} that covers a correspondingly large total beam angle θ_{T}. Mirror system MS allows for system 100 to measure a greater portion of object surface 22 in a single scan than is otherwise possible by simply scanning the portion of the object surface that faces laser source 112.

Specifically, with reference to FIG. 2C and FIG. 2D, object 20 can be considered to have different surface portions—namely a “front” or “exposed” surface portion 22A that faces laser source 112 and that is illuminated directly by laser source 112, and at least one “back” or “unexposed” or “hidden” surface portion, such as two hidden surface portions 22B and 22C, that are not directly accessible by laser beam 116 (i.e., cannot be illuminated directly by laser beam 116) with the system 100 and object 20 in that configuration.

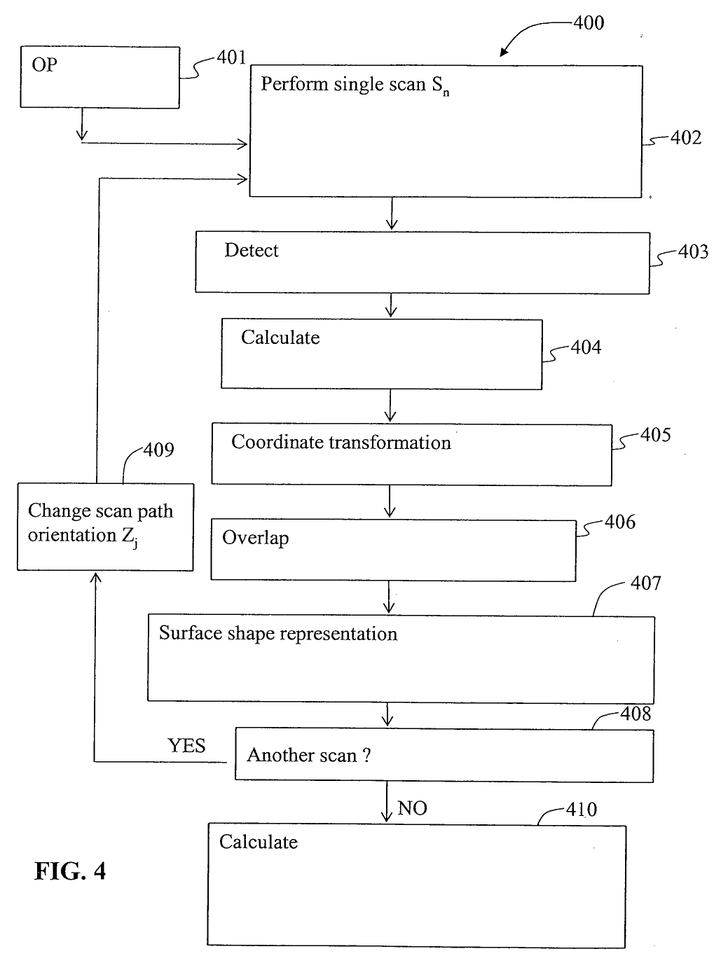

Mirror M1 of mirror system MS allows for a single scan path SP_{T} (i.e., a single pass of laser beam 116) to measure the surface shape of both the exposed surface portion 22A and the hidden surface portion 22B. With reference now also to flow diagram 400 of FIG. 4, this is accomplished as follows. In one embodiment, the procedure is: place object in position OP 401; then perform single scan Sn over n scan path segments SPₙ of scan path SP_{T} for given orientation Zj to scan exposed surface portion and at least one hidden surface portion 402, then detect direct reflection and mirror reflection(s) associated with n scan segments SPₙ 403, then calculate surface shapes segments SSₙ for scan path segments SPₙ 404, then perform coordinate transformation to properly orient surface shapes segments SSₙ 405, then determine overlap regions for adjacent calculated surface shape segments SSₙ 406, then combine calculated surface shape segments SSₙ to arrive at a surface shape representation SS_{Zn} for the given orientation 407, then ask: Perform scan at another scan path orientation? 408, and if the answer is yes, then change scan path orientation Zⱼ and return to performing the single scan (402) 409, and if the answer is no, calculate final 3D surface profile representation SPR_{F} based on the m measured 2D surface shapes representations SS_{Zm} for each scan path orientation Z₁, . . . Zₘ 410.

That is, first, in step 401, object 20 is placed in system 100 in object position OP (FIG. 2A). This is accomplished, for example, by supporting object 20 in object holder 30 or object holder 36 (FIG. 3B and FIG. 3C, respectively). Next, in step 402, laser beam 116 is scanned over scan path SP_{T} at a first orientation with respect to object 20. For the sake of illustration, the scan orientations are in the X-Y plane at different Z-positions Zⱼ=Z₁, . . . Zₘ. For the first scan orientation, Zⱼ=Z₁. In step 403, the reflected light 116R from scanned spot 118 as formed by laser beam 116 is detected by photodetector 114.

Scan path SP_{T} can be divided into a number n of scan path segments SPₙ. In the present exemplary embodiment, n=2, so that there are two scan path segments SPₙ, namely SP₁ and SP₂. As illustrated in FIG. 2C, laser beam 116 is scanned over the first scan path segment SP₁ wherein the laser beam is incident upon mirror M1, which is positioned to reflect the laser beam onto hidden surface portion 22B. A portion 116R of laser beam 116 reflects from hidden surface portion 22B at the location where laser spot 118 is formed. This reflected light then reflects from mirror M1 and is directed back toward photodetector 114, which captures and detects the reflected light (e.g., images the reflected laser spot onto a one or more pixels in a CCD array). As laser beam 116 scans over scan path segment SP₁, laser spot 118 scans across hidden surface portion 22B, which in turn scans across photodetector 114. In response thereto, photodetector 114 generates corresponding detector signals SD₁. Detector signals SD₁ contain surface shape (profile) information about hidden surface portion 22B.

As laser beam 116 continues its scan over scan path SP_{T}, it moves from first scan path segment SP₁ to second scan path segment SP₂. As illustrated in FIG. 2D, for second scan path segment SP₂, light from scanned laser spot 118 reflects from exposed surface portion 22A and is detected by photodetector 114, which sends corresponding detector signals SD₂ to processor 120. Detector signals SD₂ contain surface shape information about exposed surface portion 22A.

In step 404, processor 120 calculates surface shape segments SSₙ (i.e., SS₁ and SS₂) for both the hidden and exposed surface portions 22B and 22A based on the information provided in corresponding detector signals SDₙ (i.e., signals SD₁ and SD₂) for the corresponding scan path segments SP₁ and SP₂. FIG. 5 illustrates a plot of the resulting surface shape segments SS₁ and SS₂.

Because mirror M1 makes an angle θ_{M1} with system central axis A₁, surface shape segment SS₁ corresponding to scan path segment SP₁ needs to be rotated relative to surface shape SS₂ corresponding to scan path segment SP₂. Thus, in step 405, processor 120 performs a coordinate transformation on surface shape segment SS₂. In an exemplary embodiment, processor 120 stores surface shape segments SS₁ and SS₂ as sets of data points representing the coordinates (e.g., Cartesian coordinates) of each of the surface points measured during the laser scan. A mathematical operation is then performed to carry out the appropriate coordinate transformation, as described below.

In an exemplary embodiment, scan path segments SP₁ and SP₂ partially overlap so that a portion of surface 22 is measured more than once. In step 406, the portions of surface shape segments SS₁ and SS₂ that overlap are calculated based, e.g., on the geometry of system 100, or by comparing adjacent surface shapes in processor 120 to find surface features common to both surface shape segments. In 407, and as illustrated in FIG. 5, the surface shape segments SS₁ and SS₂ are combined to form a measured surface shape representation SS_{Zj} for the first measurement orientation Z₁. Measured surface shape representation SS_{Zn} is a two-dimensional (2D) representation of the actual shape of object surface 22 for a slice of object 20 taken at Z=Zⱼ. Note that in this particular exemplary embodiment only one of the hidden surface portions 22B is measured, which results in a gap G_{22C} in the measured surface shape representation SS_{Zj} at the location corresponding to hidden surface portion 22C.

Step 408 inquires as to whether another scan is to be performed at a different scan orientation other than Zⱼ=Z₁. If the answer to this inquiry is “YES,” then the scan orientation is changed (e.g., from Z₁ to Z₂) in step 409 and the above-described steps 402 through 407 are repeated to generate another surface shape representation SS_{Z2} for the second scan orientation. Steps 402-407 can be repeated numerous times (say, m times) until at step 407 the answer to the inquiry becomes “NO.” At this point, the process moves to step 410, wherein a final three-dimensional (3D) surface profile representation SPR_{F} calculated in processor 120 by combining the m 2D surface shape representations SS_{Z1}, . . . SS_{Zm} for the various scan orientations Z₁, . . . Zₘ.

Note that in the above-described non-contact surface measurement process, object 20 is not rotated (e.g. with respect to laser source 112) in order to scan hidden object surface portion 22B. Rather, mirror M1 allows hidden surface portion 22B to be measured using a single scan over scan path SP_{T}. This is a particularly important feature when it is preferred that object 20 not be rotated, e.g., in the case where rotation of the object can change its surface shape or other properties that need to be kept constant. As compared to known measurement processes, the overall length of scan path SP_{T} is greater because it needs to include mirror M1; however, laser beam scanning speeds are very rapid (e.g., hundreds or thousands of scans per second), and the greater length is generally not significant.

### Two-Mirror Embodiment

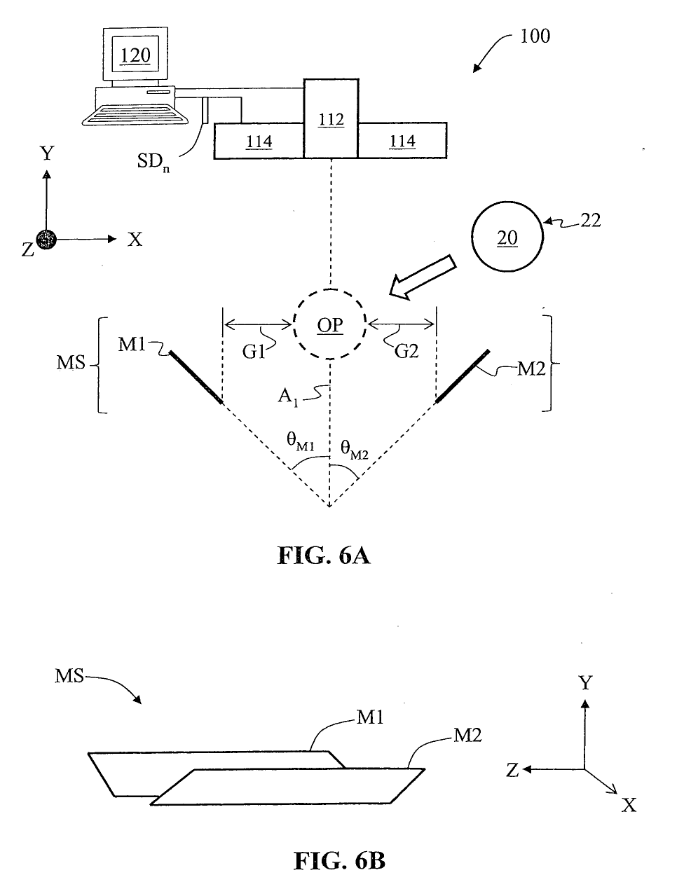

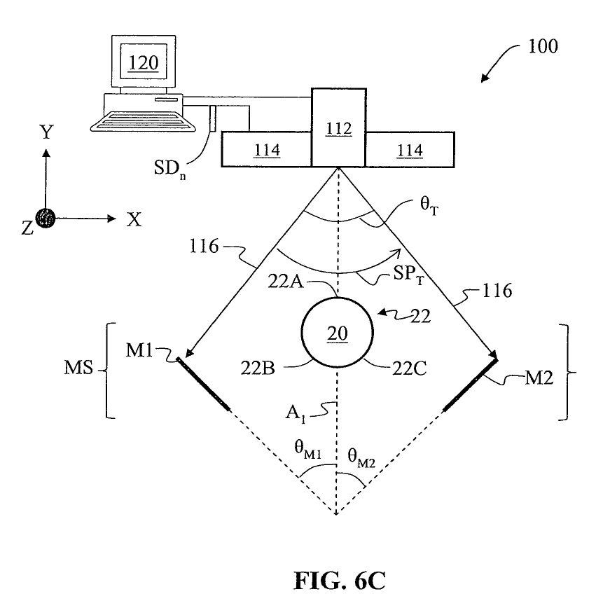

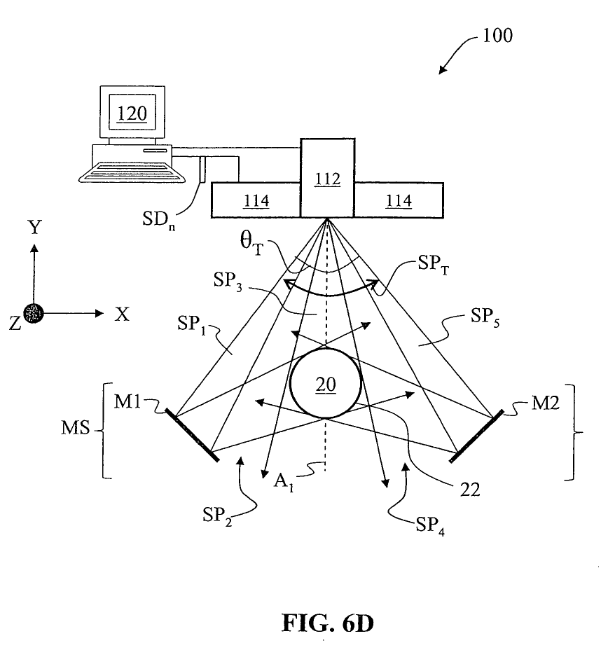

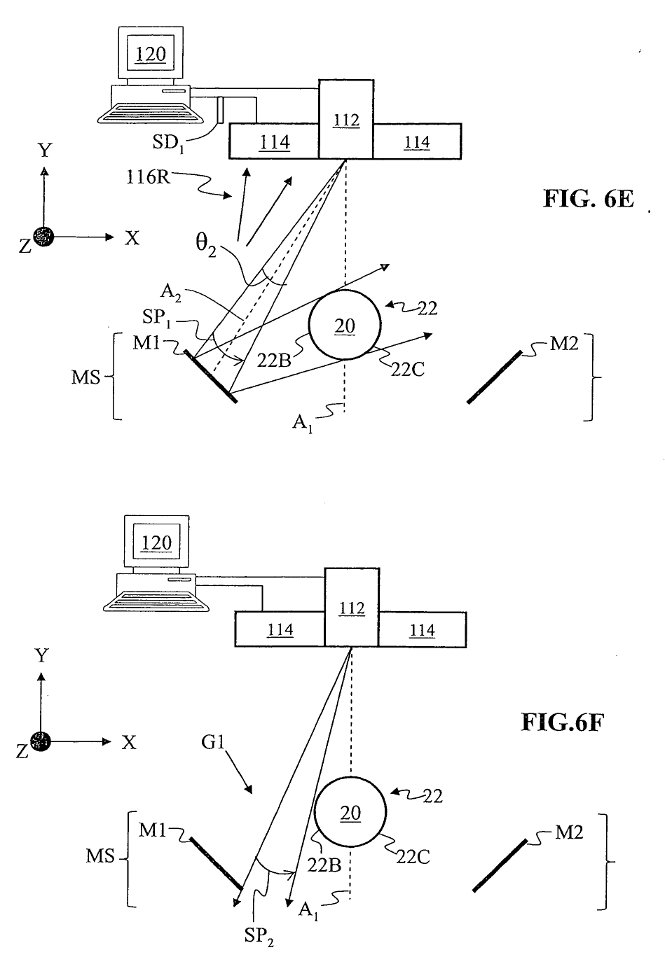

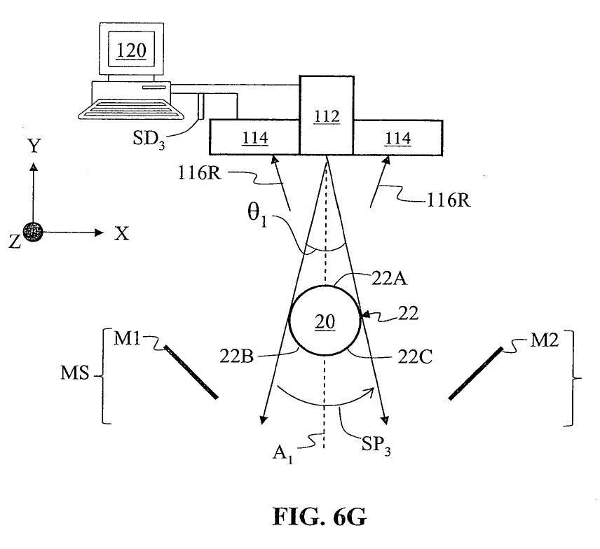

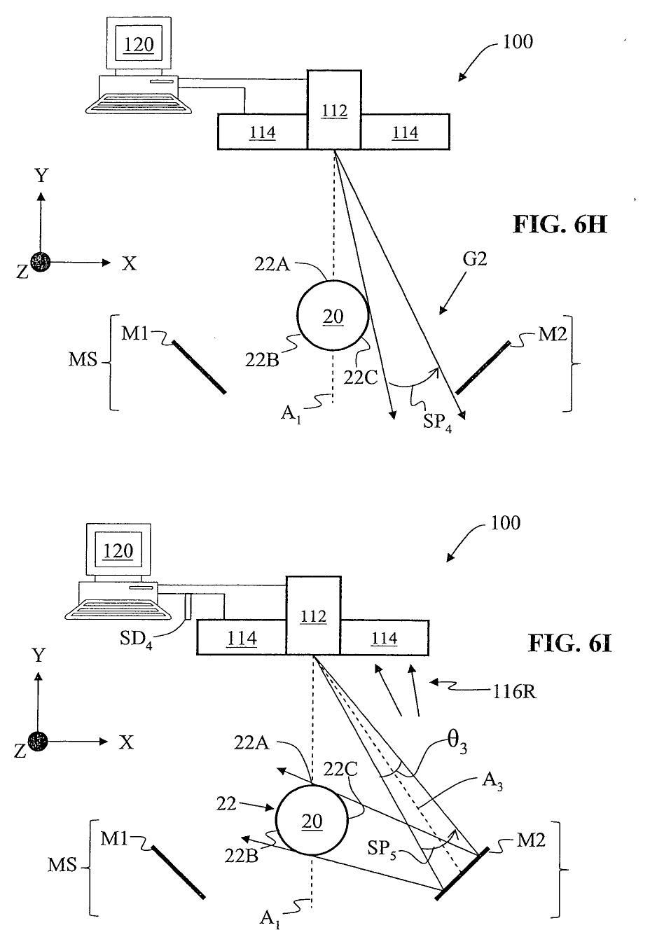

FIG. 6A is a schematic diagram of another exemplary embodiment of the laser scanning measurement system 100 similar to that shown in FIG. 2A, but wherein mirror system MS of system 100 of FIG. 6A comprises an additional mirror M2 located on the opposite side of axis A₁ from mirror M1. In a preferred embodiment, mirrors M1 and M2 are plane mirrors, as shown. Mirrors M1 and M2 can also be sections of a single mirror. Mirror M2 makes an angle θ_{M2} with respect to axis A₁. In an exemplary embodiment, mirrors M1 and M2 are arranged symmetrically about axis A₁ such that θ_{M1}=θ_{M2}. FIG. 6B is a schematic perspective diagram of an exemplary embodiment of mirror system MS that comprises two plane mirror sections that run parallel to the Z-axis and thus along the length of axis A₁ of object 20.

As illustrated in FIG. 6C and FIG. 6D, scan path SP_{T} and associated beam angle θ_{T} cover both mirrors M1 and M2. Mirrors M1 and M2 of mirror system MS allow for system 100 to measure in a single scan path SP_{T} (i.e., a single pass of laser beam 116) the 2D surface shape of an entire circumference Cₙ of object surface 22. Note that in the present exemplary embodiment, object surface 22 has a hidden surface portion 22C similar to hidden surface portion 22B but on the other side of axis A₁ (FIG. 6C).

With reference again to flow diagram 400 of FIG. 5, the surface shape of object 20 is measured in a similar manner to the first exemplary embodiment described above. First, in step 401, object 20 is placed in system 100 in object position OP (FIG. 6A). This is accomplished, for example, by supporting object 20 in object holder 30 or object holder 36 (FIG. 3B and FIG. 3C, respectively). Next, in step 402, as illustrated in FIG. 6C, laser beam 116 is scanned over scan path SP_{T} at a first orientation with respect to object 20. For the sake of illustration, the first orientation is in the X-Y plane at Z=Z₁. In step 403, the reflected light 116R from scanned spot 118 as formed by laser beam 116 is detected by photodetector 114.

Scan path SP_{T} is again divided into n scan path segments SPₙ (FIG. 6D) for the sake of convenience and illustration. In the present exemplary embodiment, n=5, so that there are five scan path segments SPₙ=SP₁ through SP₅. With reference now to FIG. 6E, as in the first exemplary embodiment, scanning laser beam 116 over the first scan path segment SP₁ directs the laser beam to mirror M1, and in response thereto, photodetector 114 generates corresponding detector signals SD₁ as described above. Detector signals SD₁ contain surface shape information about hidden surface portion 22B.

With reference now to FIG. 6F, as laser beam 116 continues its scan over scan path SP_{T}, it moves from first scan path segment SP₁ to second scan path segment SP₂. In the present exemplary embodiment, there is a first gap G1 between mirror M1 and object 20 through which laser beam 116 travels without reflecting from the object or the mirror. Accordingly, no detector signals SD₂ are generated for this scan path segment SP2.

With reference now to FIG. 6G, laser beam 116 continues to third scan path segment SP₃, wherein reflected light 116R from scanned laser spot 118 reflects from exposed surface portion 22A. This reflected light is detected by photodetector 114, which sends corresponding detector signals SD₃ to processor 120. Detector signals SD₃ contain surface shape information about exposed surface portion 22A.

With reference now to FIG. 6H, laser beam 116 then continues to fourth scan path segment SP₄, which like scan path segment SP₂, is associated with a second gap G2 between object 20 and mirror M2. Consequently, laser beam 116 travels without reflecting from the object or mirror M2. Accordingly, no detector signals SD₃ are generated for this scan path segment SP₃.

With reference now to FIG. 6I, laser beam 116 then continues to fifth scan path segment SP₅, wherein laser beam 116 is directed to mirror M2, which is positioned to reflect the laser beam onto hidden surface portion 22C. A portion 116R of laser beam 116 reflects from hidden surface portion 22C at the location where laser spot 118 is formed. This reflected light then reflects from mirror M2 and is directed back toward photodetector 114, which captures and detects the reflected light (e.g., images the reflected laser spot onto a one or more pixels in a CCD array). As laser beam 116 scans over scan path segment SP₅, laser spot 118 scans across hidden surface portion 22C, which in turn scans across photodetector 114. In response thereto, photodetector 114 generates corresponding detector signals SD₅. Detector signals SD₅ contain surface shape (profile) information about hidden surface portion 22C. Note that FIG. 6D illustrates the combined scan path segments SP₁ through SP₅ that make up the total scan path SP_{T}.

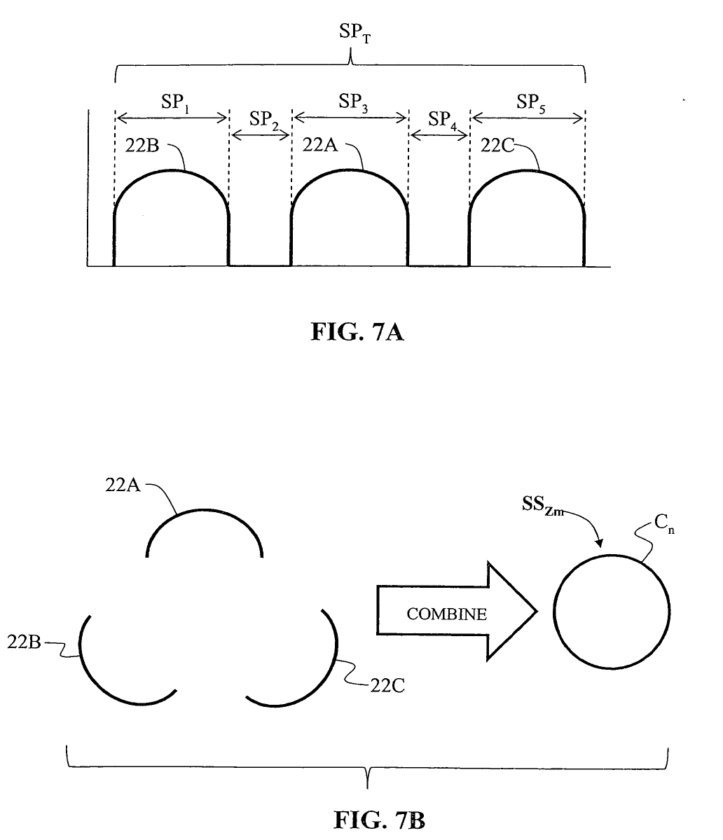

In step 404, and as illustrated in FIG. 7A, processor 120 calculates surface shape segments SSₙ (i.e., SS₁ through SS₅) for both the hidden surface portions 22B and 22C as well as exposed surface portion 22A based on the information provided in corresponding detector signals SD₁ through SD₅.

Because mirrors M1 and M2 make angles θ_{M1} and θ_{M2} with system central axis A₁, surface shape segment SS₁ corresponding to scan path segment SP₁ and surface shape segment SS₅ corresponding to scan path segment SP₅ need to be rotated relative to surface shape segment SS₃ corresponding to scan path segment SP₃. Thus, in step 405, processor 120 performs a coordinate transformation on surface shape segments SS₁ and SS₅ relative to surface shape segment SS₃. In an exemplary embodiment, processor 120 stores surface shape segments SS₁, SS₃ and SS₅ as sets of data points representing the coordinates (e.g., Cartesian coordinates) of each of the surface points measured during the laser scan. A mathematical operation is then used to carry out the appropriate coordinate transformations, as described in detail below.

In an exemplary embodiment, scan path segments SP₁, SP₃ and SP₅ partially overlap so that portions of surface 22 are measured more than once. In step 406, the portions of surface shape segments SS₁, SS₃ and SS₅ that overlap with the adjacent surface shape segment are calculated based, e.g., on the geometry of system 100, or by comparing the surface shape segments in processor 120 to find surface features common to the surface shape segments. In step 407, and as shown in FIG. 7B, the surface shape segments SS₁, SS₃ and SS₅ are properly overlapped and combined form a completed 2D surface shape representation SS_{Zj} for the first measurement orientation Zⱼ=Z₁ that covers most if not all of the entire circumference Cₙ for the given scan path orientation. The result shown in FIG. 7B is for the example case where an entire circumference Cₙ of surface 22 is scanned for the given scan path. In cases where object 20 is held by an object holder that covers or otherwise blocks access to a portion of object surface 22 by scanning laser beam 116 (e.g., V-type object holder 36), a small portion of the object surface remains unmeasured.

Step 408 inquires as to whether another scan is to be performed at a different scan orientation other than Zⱼ=Z₁. If the answer to this inquiry is “YES,” then the scan orientation is changed (i.e., from Z₁ to Z₂) in step 409 and the above-described steps 402 through 407 are repeated to generate another surface shape representation SS_{Z2} for the second scan orientation. Steps 402-407 can be repeated numerous times (say, m times) until at step 507 the answer to the inquiry becomes “NO.” At this point, the process moves to step 410, wherein a final 3D surface profile representation SPR_{F} is calculated in processor 120 by combining the 2D surface shape representations SS_{Z1}, . . . SS_{Zm} for the various (m) scan orientations Z₁, . . . Zₘ.

Again, in the above-described non-contact surface measurement process, object 20 need not be rotated in order to scan hidden object surface portions 22B and 22C. Rather, mirrors M1 and M2 allow for hidden surface portions 22B and 22C to be measured using a single scan of laser beam 116 over its scan path SP_{T}.

### Coordinate Transformations

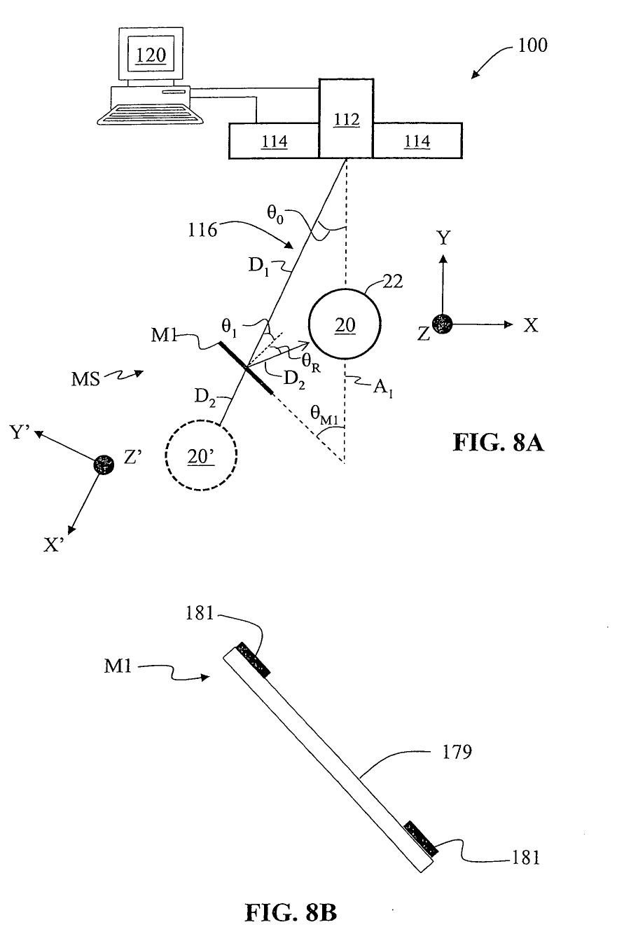

FIG. 8A is a schematic diagram of laser scanning measurement system 100 similar to that shown in FIG. 2A, illustrating the geometry associated with performing the coordinate transform used to piece together the different surface shape representations SS. The geometry is described for an example system 100 having a mirror system MS with a single plane mirror M1.

In an exemplary embodiment, the relevant geometrical information for performing the coordinate transformation is recorded by or is programmed into system 100. This information comprises, for example, the incident angle θ₀ of laser beam 116 at mirror M1, and the (X,Y) position where laser spot 118 reflects from object surface 22. This information is sufficient to generate a surface shape representation SS of exposed surface portion 22A.

System 100 also generates reflected or “virtual” Cartesian coordinates X′-Y′-Z′ associated with a virtual image 20′ (hereinafter, the “virtual object”) of “real” object 20 as formed by mirror M1. Since the Z coordinate remains unchanged, the other two virtual object coordinates (X′,Y′) need to be transformed into the (X,Y) coordinates of the real object in order for the surface shapes to be combined in their proper orientation. To do this, the position and angle of mirror M1 relative to laser beam 116 must be known.

At least two methods can be used for determining the relative position and angle of mirror M1. The first method is to replace the mirror with an opaque object (not shown) and then scan the opaque object's surface to generate a table of (X, Y) coordinates as a function of scan angle θ₀. Once the calibration is completed, the opaque object is replaced with the mirror. The coordinate table is then used to carry out the coordinate transformation (X′,Y′)→(X,Y).

With reference to the close-up view of FIG. 8B, a second method is to provide the reflective surface 179 of mirror M1 with two opaque stripes 181 and 183 at opposite ends of the mirror, as shown. Opaque stripes 181 and 183 extend in the Z-direction so as not to significantly disrupt the view of object 20. In this second method, stripes 181 and 183 show up in each object scan and provide two points that indicate the position of mirror M1. These two points are then used to generate the slope and intercept of the mirror plane in the (X,Y) coordinate space as a function of laser beam incident angle θ₀.

In addition to knowing the distance D1 from laser source 112 to mirror M1, laser beam angle θ₀ and mirror angle θ_{M1}, the distance D2 from mirror M1 to the object at the (X,Y) location of laser spot 118 needs to be established.

System 100 measures the (X′,Y′) position of the virtual object surface 22′ for a given laser beam incident angle θ₀ by the equation:

X′=−(D1+D2)sin(θ₀) (Eq. 1A)

Y′=−(D1+D2)cos(θ₀) (Eq. 1B)

The position of the real object point in the (X,Y) coordinate space is then determined by the coordinate transformation:

X=−D1 sin(%)+D2 cos(2θ_{M1}+θ₀−90°) (Eq. 2A)

Y=−D1 cos(θ₀)+D2 sin(2θ_{M1}+θ₀−90°) (Eq. 2B)

In the above set of equations, D2 is unknown. However, the above equations can be combined to produce the following coordinate transformation:

X=−D1 sin(θ₀)+(D1 sin(θ₀)−X′)(cos(2θ_{M1}+θ₀−90°)/sin(θ₀) (Eq. 3A)

Y=−D1 cos(θ₀)+(D1 sin(θ₀)−X′)(sin(2θ_{M1}+θ₀−90°)/sin(θ₀) (Eq. 3B)

The coordinate transformation for mirror M2 is analogous. Coordinate transformations for non-planar mirrors is more complicated but can be determined in a straightforward manner by one skilled in the art through a number of different approaches, including using ray-tracing software such as CODE V® or LightTools®, both available from Optical Research Associates, Inc., Pasadena, Calif.

### Example Application

### Extruded Ware Surface Shape Measurement

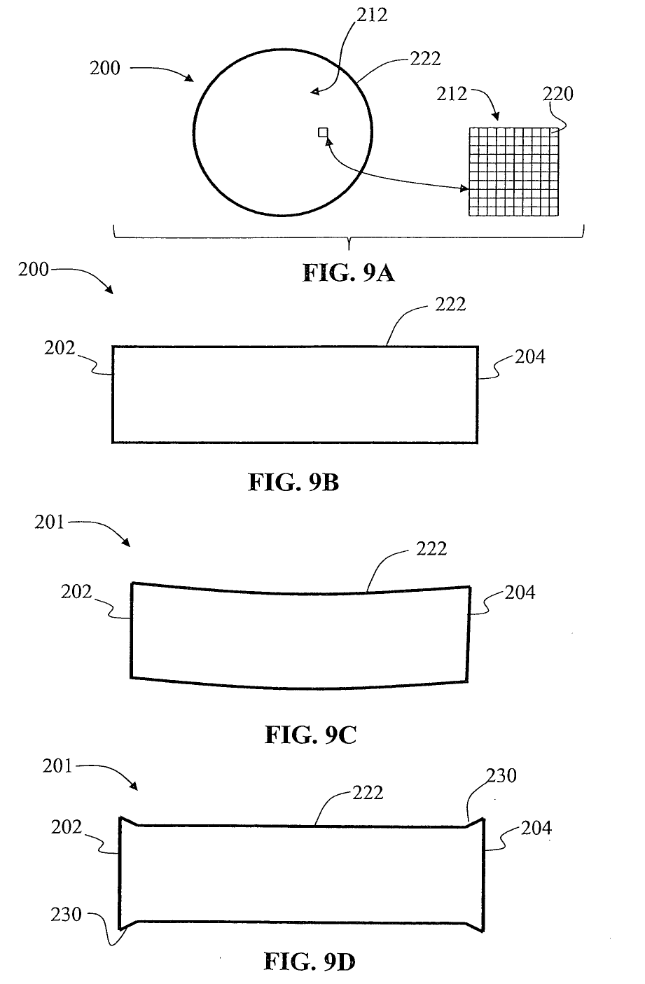

An example application for the laser scanning measurement system 100 of the present invention is for measuring the surface shape of extruded particulate filters. FIG. 9A is an end view and FIG. 9B is a side view of an example particulate filter body (“filter”) 200 having opposite end faces 202 and 204 and an internal honeycomb structure 212 that comprises a number of cell channels 220 that extend between the end faces (see inset of FIG. 9A). Filter 200 has an outer surface 222.

Versions of filter 200 are formed, for example, from an aqueous-based ceramic precursor mixture fed through an extrusion die to form a wet “log.” The aqueous-based ceramic precursor mixture comprises, for example, a batch mixture of ceramic (such as cordierite) forming inorganic precursor materials, an optional pore former such as graphite or starch, a binder, a lubricant, and a vehicle. The wet log is then cut during the extrusion step into a number of pieces. These pieces are then dried to form “green” honeycomb logs.

The process of forming filter 200 further involves cutting or segmenting the green honeycomb pieces into green honeycombed structures of a desired length, and thereafter removing dust from the green honeycombed structures as formed during the cutting step. At this point, the honeycombed structure can be fired and then plugged at the ends. This may involve, for example, charging or otherwise introducing a flowable plugging cement material, such as a slurry preferably comprising a water diluted ceramic-forming solution, into selected cell channels 220 as determined by a plugging mask.

Because filter 200 is typically designed to fit into an enclosure of a very specific size and shape (e.g., the housing for a catalytic converter for an automobile), the surface shape of the filter needs to satisfy relatively tight specifications. Yet, because the extruded log does not have a hard outer surface, contact-type surface measurements can damage and/or deform the filter and change its surface shape. Thus, non-contact measurement of the surface shape of filter 200 along its various stages of manufacture is an important aspect of monitoring filter quality.

For example, if the extrusion process is not uniform, the logs 201 used to form filter 200 can have a bowed shape (FIG. 9C), or can have a shape that differs from its ideal shape, such as a certain dimension oval for use in catalytic converters. In addition, the cutting of log 201 into pieces can cause surface 222 at log ends 202 and 204 to have respective defects or distortions such as flares 230 due to differences in the stress-strain balance at the log ends (FIG. 9D). Flares 230 tend to happen within a short distance of the log ends. To the extent that shape defects occur in the manufacturing process, they need to be quickly measured and quantified to assess whether the resulting product will have a surface shape within the design tolerance. Further, the surface measurements are preferably taken over most if not all of the object's circumference. Accordingly, the surface measurements provided by the laser scanning measurement system of the present invention allow for a quick surface shape inspection of the extruded parts without having to rotate the parts. This is particularly important in the case of extruded logs since rotating the log may cause deformation of the surface shape.

In one aspect, a laser measurement system is disclosed herein comprising: a laser source adapted to scan a laser beam over a scan path relative to an object at an object position; a mirror system arranged relative to the laser source and to the object position such that the scanned laser beam is incident directly on an exposed portion of an object surface of the object and is incident via reflection by the mirror system onto at least one hidden portion of the object surface that is not directly accessible by the scanned laser beam; and a photodetector configured relative to the laser source, the mirror system and the object position so as to detect light from the scanned laser beam that reflects from the exposed surface portion and that reflects from the at least one hidden portion of the object surface. Preferably, the object does not move with respect to the laser source. Preferably, the object does not rotate. In some embodiments, the object has a circumference, and the system comprises a plurality of mirrors, and the mirrors are arranged such that the object surface is measured around the entire circumference. Preferably, the object is capable of not moving with respect to the laser source. In some embodiments, the scanning laser beam and the mirror are configured so as to provide a plurality of laser beam scans at different scan path orientations relative to the object position so as to provide a corresponding plurality of surface measurements that can be combined to form a three-dimensional surface profile representation of the object surface. In some embodiments, the system further comprises a processor adapted to receive detector signals from the photodetector corresponding to the light detected over the scanning path and process the detector signals to determine a surface shape representation of the object surface. In some embodiments, the system comprises a plurality of mirrors. In some embodiments, the mirror is a plane mirror.

In another aspect, a method is disclosed herein of performing a non-contact measurement using a laser beam, the method comprising: scanning a first portion of an object surface of an object by irradiating the first portion with the laser beam; scanning a second portion of the object surface with the laser beam by reflecting the laser beam to said second portion, wherein said second surface portion cannot be directly irradiated by the laser beam; detecting light reflected by the first surface portion and second hidden surface portion; and determining a surface shape representation of the object surface based on the detected light. In some embodiments, a single scan of the laser beam is utilized. In some embodiments, the laser beam emanates from a laser source, and the object does not move with respect to the laser source during the scanning of the first and second portions. In some embodiments, the laser beam emanates from a laser source, and the object does not rotate during the scanning of the first and second portions. In some embodiments, the reflecting of the laser beam further comprises reflecting the scanning laser beam from at least one mirror. In some embodiments, the object has a circumference, and the second surface portion plus the first surface portion substantially covers the circumference, and determining the surface shape representation further comprises determining the surface shape representation for the circumference. In some embodiments, the determining the surface shape representation based on the detected light comprises: dividing up the scan path into a number of scan path segments; calculating surface shape segments associated with the scan path segments; and combining the surface shape segments to form the surface shape representation. The method may further comprise performing a coordinate transformation to orient the surface shape segments relative to one another prior to said combining of surface shape segments. In some embodiments, a portion of each surface shape segment overlaps with an adjacent surface shape segment, and the method further comprises: determining said surface shape segment overlaps, and accounting for said overlaps when combining the surface shape segments to arrive at the surface shape representation. In some embodiments, the surface shape representation formed by a) canning a first portion of an object surface of an object by irradiating the first portion with the laser beam, (b) scanning a second portion of the object surface with the laser beam by reflecting the laser beam to said second portion, wherein said second surface portion cannot be directly irradiated by the laser beam, (c) detecting light reflected by the first surface portion and second hidden surface portion, and (d) determining a surface shape representation of the object surface based on the detected light, is a 2D surface shape representation, and the method further comprises repeating steps a) through d) for a plurality of different scan paths to form a three-dimensional (3D) object surface profile representation.

In another aspect, a laser scanning measurement system is disclosed herein comprising: a laser source adapted to provide a scanning laser beam that scans over a scan path; an object holder adapted to hold an object at an object position relative to the laser source such that the object has an object surface comprised of an exposed surface portion, upon which the scanned laser beam can be made directly incident, and at least one hidden surface portion, upon which the scanned laser beam cannot be made directly incident; a mirror arranged relative to the object holder and to the laser source such that the scanned laser beam can be made incident upon the at least one hidden surface portion as the laser beam is scanned over the scan path; a photodetector adapted to receive detected light comprised of light reflected directly from the exposed surface portion and light reflected from the at least one hidden surface portion, and to generate detector signals corresponding to said detected light from said surface portions; and a processor adapted to receive and process the detector signals to determine a surface shape representation of the object surface. In some embodiments, the object holder holds the object stationary with respect to the laser source. In some embodiments, the measurement system comprises a plurality of mirrors configured such that the scanning laser beam can be made indirectly incident upon all of the hidden surface portions so that the surface shape representation can be determined for a circumference of the object over a single laser beam scan taken over the scan path. In some embodiments, the scan path comprises a plurality of scan path segments, and wherein the processor is adapted to calculate for each scan path segment a corresponding surface shape segment and to combine the surface shape segments to form said surface shape representation. In some embodiments, the processor is further adapted to perform a coordinate transformation of at least one of the surface shape segments so as to place the surface shape segments in a spatial orientation relative to one another. In some embodiments, at least two of the scan segments overlap, and wherein the processor is adapted to calculate said overlap. In some embodiments, the processor is adapted to process detector signals for scans taken from different scan path orientations and to calculate a three-dimensional (3D) object surface profile representation based on said detector signals in order to determine the surface shape representation.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A laser measurement system comprising:
a laser source adapted to scan a laser beam over a scan path relative to an object at an object position;
a mirror system arranged relative to the laser source and to the object position such that the scanned laser beam is incident directly on an exposed portion of an object surface of the object and is incident via reflection by the mirror system onto at least one hidden portion of the object surface that is not directly accessible by the scanned laser beam; and
a photodetector configured relative to the laser source, the mirror system and the object position so as to detect light from the scanned laser beam that reflects from the exposed surface portion and that reflects from the at least one hidden portion of the object surface.

2. The system of claim 1 wherein the object has a circumference, wherein the system comprises a plurality of mirrors, and wherein the mirrors are arranged such that the object surface is measured around the entire circumference.

3. The system of claim 1 wherein the scanning laser beam and the mirror are configured so as to provide a plurality of laser beam scans at different scan path orientations relative to the object position so as to provide a corresponding plurality of surface measurements that can be combined to form a three-dimensional surface profile representation of the object surface.

4. The system of claim 1 further comprising:
a processor adapted to receive detector signals from the photodetector corresponding to the light detected over the scanning path and process the detector signals to determine a surface shape representation of the object surface.

5. The system of claim 1 wherein the system comprises a plurality of mirrors.

6. The system of claim 1 wherein the mirror is a plane mirror.

7. A method of performing a non-contact measurement using a laser beam, the method comprising:
scanning a first portion of an object surface of an object by irradiating the first portion with the laser beam;
scanning a second portion of the object surface with the laser beam by reflecting the laser beam to said second portion, wherein said second surface portion cannot be directly irradiated by the laser beam;
detecting light reflected by the first surface portion and second hidden surface portion; and
determining a surface shape representation of the object surface based on the detected light.

8. The method of claim 7 wherein a single scan of the laser beam is utilized.

9. The method of claim 7 wherein the laser beam emanates from a laser source, and wherein the object does not move with respect to the laser source during the scanning of the first and second portions.

10. The method of claim 7 wherein the laser beam emanates from a laser source, and wherein the object does not rotate during the scanning of the first and second portions.

11. The method of claim 7 wherein said reflecting of the laser beam further comprises reflecting the scanning laser beam from at least one mirror.

12. The method of claim 7 wherein the object has a circumference, wherein the second surface portion plus the first surface portion substantially covers the circumference, and wherein determining the surface shape representation further comprises determining the surface shape representation for the circumference.

13. The method of claim 7 wherein the determining the surface shape representation based on the detected light comprises:
dividing up the scan path into a number of scan path segments;
calculating surface shape segments associated with the scan path segments; and
combining the surface shape segments to form the surface shape representation.

14. The method of claim 13 wherein a portion of each surface shape segment overlaps with an adjacent surface shape segment, and wherein the method further comprises:
determining said surface shape segment overlaps; and
accounting for said overlaps when combining the surface shape segments to arrive at the surface shape representation.

15. The method of claim 8 wherein the method further comprises repeating the scanning of the first portion, the scanning of the second portion, the detecting light reflected, and the determining the surface shape representation, for a plurality of different scan paths to form a three-dimensional (3D) object surface profile representation.

16. A laser scanning measurement system comprising:
a laser source adapted to provide a scanning laser beam that scans over a scan path;
an object holder adapted to hold an object at an object position relative to the laser source such that the object has an object surface comprised of an exposed surface portion, upon which the scanned laser beam can be made directly incident, and at least one hidden surface portion, upon which the scanned laser beam cannot be made directly incident;
a mirror arranged relative to the object holder and to the laser source such that the scanned laser beam can be made incident upon the at least one hidden surface portion as the laser beam is scanned over the scan path;
a photodetector adapted to receive detected light comprised of light reflected directly from the exposed surface portion and light reflected from the at least one hidden surface portion, and to generate detector signals corresponding to said detected light from said surface portions; and
a processor adapted to receive and process the detector signals to determine a surface shape representation of the object surface.

17. The system of claim 16 wherein the object holder holds the object stationary with respect to the laser source.

18. The system of claim 16 wherein the measurement system comprises a plurality of mirrors configured such that the scanning laser beam can be made indirectly incident upon all of the hidden surface portions so that the surface shape representation can be determined for a circumference of the object over a single laser beam scan taken over the scan path.

19. The system of claim 16 wherein the scan path comprises a plurality of scan path segments, and wherein the processor is adapted to calculate for each scan path segment a corresponding surface shape segment and to combine the surface shape segments to form said surface shape representation.

20. The system of claim 19 wherein the processor is further adapted to perform a coordinate transformation of at least one of the surface shape segments so as to place the surface shape segments in a spatial orientation relative to one another.

21. The system of claim 19 wherein the processor is adapted to process detector signals for scans taken from different scan path orientations and to calculate a three-dimensional (3D) object surface profile representation based on said detector signals in order to determine the surface shape representation.
